(19) United States
(12) Patent Application Publication
(10) Pub. No.: US 2006/0278097 A1
(43) Pub. Date: Dec. 14, 2006

(54) Griddle with multiple cooking areas

(76) Inventor: Daniel Piccirilli, Toms River, NJ (US)

Correspondence Address: CATALINA + ASSOCIATES, LLC, 167 AVENUE AT THE COMMON, SUITE 9, SECOND FLOOR, SHREWSBURY, NJ, 07702, US

(21) Appl. No.: 11/453,318

(22) Filed: Jun. 14, 2006

Related U.S. Application Data
(60) Provisional application No. 60/690,196, filed on Jun. 14, 2005.

(51) Int. Cl. A47J 37/10

(52) U.S. Cl. 99/422

(57) ABSTRACT

The present invention is a cooking griddle having a plurality of cooking surface areas on the surface of the griddle, each surface area capable of functioning as a separate skillet. Although the cooking surface areas function as separate skillets, there is no physical barrier that would impede the movement of food items from one cooking surface area to another cooking surface area. This unique structural design allows the user great flexibility and versatility in simultaneously preparing a variety of food types without having to use multiple skillets.

### CROSS REFERENCE TO RELATED APPLICATIONS

This application is related to, and claims priority from, U.S. Provisional Patent Application Ser. No. 60/690,196, filed on Jun. 14, 2005, by Daniel Piccirilli, titled “Skillet with Multiple Cooking Surfaces,” the contents of which are hereby incorporated by reference.

### FIELD OF THE INVENTION

The present invention relates generally to a cooking implement with multiple cooking areas, and more particularly, to a griddle or a pan designed to offer the user options in the preparation of cooking and heating multiple food items of the same or different types simultaneously over a single or multiple heat sources. As a result of its unique design, the present invention provides a plurality of cooking areas on the surface of the griddle, thereby allowing one or more items of food to be cooked simultaneously, without the problem of different foods—which may have different cook times—from commingling and interfering with each other on the surface of the griddle.

### BACKGROUND OF THE INVENTION

Griddles and pans have long been used for cooking food items such as pancakes that typically require a large surface area for heating. The main problem with conventional griddles and pans is that they only have a single defined cooking surface area for heating food items. As such, using conventional griddles and pans necessarily entails cooking one food item at a time and removing cooked food items to a separate location in order to free up space to cook additional food items. Alternately, preparing large quantities of different types of food items would require multiple pans or skillets. Clearly, using multiple pans is cumbersome, and using one pan or skillet to prepare one food item at a time can be very time-consuming and often results in cooked items that cool and/or dry out upon removal from the pan, griddle or skillet. Therefore, it is desirable to have a specially designed griddle with multiple cooking surface areas for multiple uses for a variety of cooking and reheating tasks.

The prior art has attempted to provide a number of cooking devices for simultaneously cooking multiple food items, several of which are discussed below. However, no device for simultaneously preparing various different types of food items similar to the instant invention has been found to exist.

U.S. Pat. No. 6,990,893 to Cheng (the “'893 patent”), entitled “Breakfast Griddle,” shows a griddle having a large flat cooking surface subdivided into at least one enclosed region by a convex ridge. This design is essentially one skillet having confined regions for separately cooking food items such as pancakes. As such, this design is different from the design of the present invention which provides a plurality of cooking surface areas each of which functions as a separate skillet. Furthermore, one unique feature of the present invention is the fact that there is no physical barrier which would impede the movement of food items to and from the separate cooking surface areas, whereas the griddle of the '893 patent utilizes the enclosed regions for impeding the movement of food items across the cooking surface areas.

U.S. Design Pat. No. D333,064 to Sorrel, entitled “Pancake Griddle,” also shows separate cooking surface areas, but unlike the griddle of the present invention, those separate cooking surface areas are enclosed and prevent free movement of food items to and from the separate cooking areas.

U.S. Pat. No. 6,813,994 to Williams (the “'994 patent”), entitled “Multi-Compartmented Griddle Iron,” shows a compartmentalized cooking device for simultaneously cooking multiple food items on a flat heated surface having an outer wall around the perimeter of an area and internal walls within the area for defining a plurality of compartments for receiving a food item to be cooked and for maintaining the food item separately on the heated surface. As such, the '994 patent actually teaches away from the unique structural design of the present invention which allows the free movement of food items to and from the separate cooking areas.

Other cooking pans and griddles for simultaneously cooking multiple food items generally include U.S. Pat. Nos. 6,267,047 and 5,676,043 and U.S. Design Pat. Nos. D492,538; D508,818; D393,980; and D430,458.

Accordingly, there is a great need for a cooking implement which provides multiples cooking surface areas capable of functioning as separate skillets, but which would allow free, unimpeded movement of food items to and from the separate cooking areas.

It is therefore an object of the present invention to provide a cooking implement that allows the user to cook multiple food items, which may or may not be of the same type, which would otherwise require multiple skillets or pans.

It is another object of the present invention to provide the aforementioned benefits of a cooking griddle by utilizing a unique structural design which offers greater overall effective cooking area and minimizes wasted space on the surface of the griddle.

### SUMMARY OF THE INVENTION

A griddle in accordance with the present invention includes a plurality of cooking surface areas each of which can be considered a separate skillet. Although these cooking surface areas function as separate skillets, the cooking areas are all part of and together form a single, uniform surface of the griddle. As such, there are no structural barriers between cooking areas that would impede the movement of food items from one cooking surface area to another cooking surface area and the common areas between the cooking surface areas. Accordingly, the griddle in accordance with the present invention provides one large cooking surface, defined by its shape into distinct and separate cooking areas, all with independent functionality. A primary aspect of the present invention is that the griddle of the present invention provides separate cooking surface areas that function as separate skillets to enable the user to cook multiple food items, while allowing the user to freely move the food items to and from different cooking surface areas, thereby allowing the user the versatility of utilizing different cooking surface areas for different cooking purposes, as described in further detail herein.

A preferred embodiment of the invention, therefore, is ideally suited for senior citizens, campers, tailgaters, and families alike. Furthermore, since the unique design according to the present invention allows for cooking round or odd-shaped food items, the griddle according to the present invention is ideal for all ethnic and culinary cultures.

### BRIEF DESCRIPTION OF THE DRAWINGS

These and other features of the invention will be more fully understood by references to the following drawings.

FIG. 1 is a perspective view of the griddle in accordance with the present invention.

FIG. 2 is a top plan view thereof.

FIG. 3 illustrates a cross-sectional view of the griddle, taken across the lines C-C of FIG. 2.

FIG. 4 is a perspective view of an alternative embodiment of the griddle in accordance with the present invention.

Similar reference numerals and characters denote corresponding features consistently throughout the attached drawings.

Although every reasonable attempt is made in the accompanying drawings to represent the various elements of the embodiments in relative scale, it is not always possible to do so with the limitations of two-dimensional paper. Accordingly, in order to properly represent the relationship of various features among each other in the depicted embodiments and to properly demonstrate the invention in a reasonably simplified fashion, it is necessary at times to deviate from the absolute scale in the attached drawings. However, one of ordinary skill in the art would fully appreciate and acknowledge any such scale deviations as not limiting the enablement of the disclosed embodiments.

### DETAILED DESCRIPTION OF THE PREFERRED EMBODIMENTS

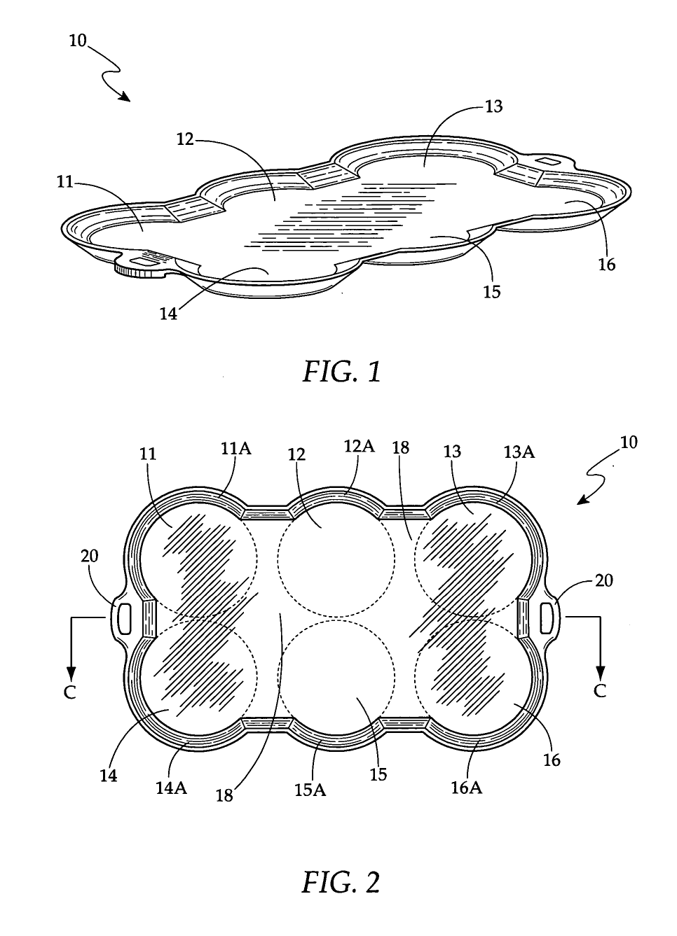

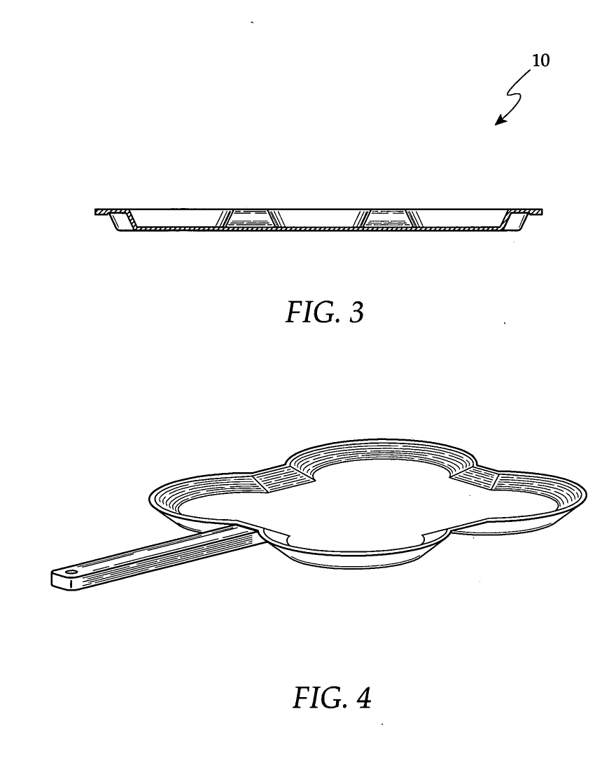

A griddle 10 having a plurality of interconnected cooking surface areas 11-16 according to a preferred embodiment of the present invention will now be described with reference to FIGS. 1-3 of the accompanying drawings.

Referring to FIGS. 1-2, in a preferred embodiment of the present invention, the griddle 10 includes six (6) separate cooking surface areas 11-16, each preferably formed in a circular configuration, although an oval or other configured shapes may also be suitable. Although there are preferably six such cooking surface areas 11-16, it is understood that the number of such cooking surface areas can range from two to any number of multiple cooking surface areas, such as three (3), four (4) or eight (8). FIG. 4, for example, shows one such alternative embodiment with four cooking surface areas.

Referring to FIG. 2 in particular, it is shown that only a portion of each cooking surface area is physically defined by various portions of a generally upstanding, i.e., substantially upward extending, peripheral wall 11a-16a. That is, the periphery of each cooking surface area 11-16 is bordered by the inner sides of various portions of the peripheral wall 11a-16a defining the overall shape of the griddle. The peripheral wall is preferably gently flared outwardly from the cooking surface. In addition, as shown in FIG. 2, the broken lines are used to indicate the boundary of various portions of the cooking surface areas 11-16, with an interspacial common area 18. Broken lines are used for this purpose, because, in a preferred embodiment of the present invention, there is no physical structure to indicate the boundary of each cooking surface area 11-16, other than the portions which abut the peripheral wall 11a-16a. In an alternative embodiment of the present invention, certain markings or slight ridges may be utilized to indicate the boundary of each separate cooking surface area, so long as such markings or slight ridges do not interfere with the free movement of food items to and from separate cooking surface areas 11-16.

In a preferred embodiment of the present invention, the cooking surface areas 11-16 are separated from each other by common area 18. As such, the cooking surface areas 11-16 and the common area 18 form one continuous large cooking surface area comprising the surface of the griddle as a whole, with each cooking surface area 11-16 capable of functioning as a separate skillet. This structural design serves the dual purpose of allowing the cooking surface areas 11-16 to serve as separate skillets, and simultaneously allowing the free movement of food items across one continuous large cooking surface—which includes separate cooking surface areas—without any physical impediment.

### EXAMPLE ONE

As an illustration, this unique structural design would allow a chef to cook pancakes on one cooking surface 11 on high heat, and as the pancakes are cooked, they can be moved to another cooking surface 16 on low heat. The chef may at the same time be cooking breakfast sausage links on the cooking surface area 14 and eggs on the cooking surface 12 on medium heat. As such, while one or more of the cooking surfaces are being used for cooking food items, the remaining cooking surfaces may simultaneously be used for temporarily storing cooked food items. A person of ordinary skill in the art would readily appreciate many other ways the griddle 10 in accordance with the present invention may be used for “multi-tasking” cooking.

In a preferred embodiment of the present invention, there is formed a handle 20 on either side of the griddle 10. The handles 20 may simply be extensions of the griddle 10. That is, the griddle 10 in accordance with the present invention may be a single unit without any separate parts. On the other hand, a person of ordinary skill in the art would readily appreciate that the handles 20 may be separate parts that can be connected to either side of the griddle 10 by means of, for instance, rivets.

Preferably, the entire griddle 10 is constructed of aluminum or other material that can withstand the intense heat of an open flame or cooking grill, such as copper, and any other suitable metals, alloys or other materials generally known to those skilled in the art. In addition, the griddle 10 may be treated with a non-stick finish, such as Teflon®, or any other non-stick finish also generally known to those skilled in the art.

### EXAMPLE TWO

The cooking surfaces 11-16 are dimensioned for cooking various sizes and shapes of food items. Examples include:
simultaneously preparing six hamburgers;
simultaneously preparing two hamburgers, fried onions, and toasted rolls;
simultaneously preparing three fish cakes and three Mexican tortillas; and
simultaneously preparing six Italian manicotti shells; etc.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the present invention pertains will be considered infringement of this invention when those modified forms fall within the claimed scope of this invention.

It would also be generally appreciated by one skilled in the art, including chefs, cooks or other users of the invention, that the present invention may be utilized for cooking an almost infinite number of types of food items.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A cooking griddle with multiple cooking surface areas, comprising:
a substantially planar cooking surface, wherein said cooking surface comprises a plurality of separate cooking surface areas; and
an upward extending peripheral wall surrounding said substantially planar cooking surface, wherein portions of said peripheral wall define portions of said separate cooking surface areas.

2. The cooking griddle according to claim 1, wherein said peripheral wall is gently flared outwardly from said substantially planar cooking surface.

3. The cooking griddle according to claim 2, wherein said plurality of separate cooking surface areas are substantially circular.

4. The cooking griddle according to claim 3, wherein said substantially planar cooking surface and said plurality of separate cooking surface areas are coplanar.

5. The cooking griddle according to claim 4, further comprising at least one handle for grasping the cooking griddle.

6. The cooking griddle according to claim 5, wherein said handle extends outwardly from said peripheral wall.

7. The cooking griddle according to claim 6, wherein said substantially planar cooking surface is treated with a non-stick finish.

8. The cooking griddle according to claim 7, wherein said non-stick finish is Teflon®.
